(19) United States
(12) Patent Application Publication
(10) Pub. No.: US 2010/0108467 A1
(43) Pub. Date: May 6, 2010

(54) APPARATUS, SYSTEM AND METHOD FOR MOVING A VEHICLE FROM DUAL BELT CONVEYOR TO DUAL BELT CONVEYOR

(75) Inventors: Bernard G. BARREYRE, Burlington (CA); Steven W. MAI, Cambridge (CA); Brett BUNSTON, King City (CA)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignees: PETRO-CANADA, Calgary (CA); ECLIPSE AUTOMATION, INC., Cambridge (CA)

(21) Appl. No.: 12/263,117

(22) Filed: Oct. 31, 2008

(51) Int. Cl. B65G 47/54; B65G 15/44; B65G 37/00; B60S 3/04

(52) U.S. Cl. 198/599; 198/844.1; 134/126; 134/127; 198/850; 198/617

(57) ABSTRACT

A system and method for transferring a vehicle from a first dual belt conveyor to a second dual belt conveyor utilizes transitions between the belts of the first and second conveyors which are offset along a direction of travel. The offset transitions result in only one wheel of the vehicle at a time crossing a transition. The transitions utilize fixed rollers positioned on either side of a plurality of recirculation rollers. The fixed rollers minimize the gap between the ends of the belts and the transitions while permitting the belts, particularly with cleats, to pass by the fixed rollers.

### FIELD OF THE INVENTION

Embodiments of the invention are directed to apparatus, systems and methods for transferring a vehicle from one dual belt conveyor to another dual belt conveyor and more particularly from at least a dual belt entrance conveyor of a car wash to a dual belt wash conveyor in the car wash wherein the vehicle may be in a variety of states including but not limited to park, neutral, foot brake engaged or emergency brake engaged.

### BACKGROUND OF THE INVENTION

Conveyance systems are well known for moving vehicles along a direction of travel, such as along an assembly line in an automotive assembly plant or through a car wash tunnel.

One type of conveyor utilized particularly in conventional car washes is a chain conveyor having spaced, large, upwardly extending lugs which positively engage a wheel of the vehicle and act to drag the vehicle through the car wash tunnel. The vehicle's transmission is placed in neutral to permit the wheels of the vehicle to rotate on the floor of the carwash tunnel as the vehicle is dragged by the lug. The engaged wheel is guided throughout the car wash tunnel by tracks which align the wheels and prevent skewing of the vehicle. Should the wheels of the vehicle be prevented from rotating, such as by placing the drivetrain in Park or one or more of the footbrake or the emergency brake being engaged, the vehicle may be damaged when engaged with the lug.

It is known in the automotive industry, particularly in the assembly thereof, to utilize endless belt conveyors to support and carry a vehicle on the belt(s) along the direction of travel. The conveyor may comprise a single belt or dual, spaced apart, substantially parallel belts. A surface of the belts may or may not be cleated. Where two or more end-to-end conveyors are utilized to move the vehicle the desired distance, the vehicle must be transitioned across a gap formed therebetween. One common transition used in belt-to-belt transfer is a plate positioned across the gap between the belts. Another common transition is one or more rollers positioned in the gap.

Vehicles carried on belt conveyors typically have the wheels locked and therefore non-rotatable, such as when the drivetrain is in Park or when brakes, including the emergency brake, are applied. In the locked state, the wheels of the vehicle are carried by the conveyor surface and movement of the conveyor supplies sufficient momentum to overcome any force encountered by the wheels at the conventional transition. If however the vehicle's drivetrain is placed in neutral and the wheels are rotatable, the momentum caused by the conveyor would merely cause the wheels engaged in the gap to rotate and the vehicle would not be advanced over the gap or the conventional transition. Thus, conventional belt conveyor systems either require that the wheels be in a locked state to permit transition from belt to belt.

U.S. Pat. No. 7,278,533 to Horn teaches two, dual, endless belt conveyors oriented end-to-end for use in a carwash. Horn requires that the vehicle's drivetrain be placed in Park once the vehicle has been driven onto the entrance conveyor to lock the wheels against rotation. The locked wheels are thereafter pushed by the momentum of the conveyor over a single transfer roller fit within the gap between the entrance conveyor and the wash conveyor.

Despite warnings to the contrary, it is known that operators may place the vehicle in the locked state or the freewheeling state. This becomes particularly problematic in unmanned car washes which utilize belt conveyors and the vehicle's operator places the vehicle in neutral. The wheels are therefore freewheeling and can hang up in gaps at the transitions between belts, the vehicle potentially becoming stalled at the transition. Further, the vehicle may skew if passed over the transition, particularly if the rotatable wheels are not aligned with the direction of travel.

As a further complication in belt conveyors, Applicant believes that should the wheels be placed in the locked state and the vehicle successfully reach an end of the conveyor, the vehicle may be damaged as the front wheels of the vehicle exit from the final conveyor onto a surface outside the carwash while the rear wheels remain on the moving conveyor.

As well safety concerns are well known in the industry whenever there is a gap or nip formed between rollers or belts. It is possible that should the gap be large enough, personnel may engage with the gap, such as with their feet and severe injury is known to result.

Thus, there is an interest, particularly in the car wash industry, for a conveyance system for vehicles which provides safe and reliable movement of a vehicle, regardless the rotational state of the wheels of the vehicle, permits unimpeded and aligned transfer of the vehicle from belt to belt in a multi-conveyor system and minimizes any gap between conveyors and transitions therebetween to prevent personnel injury.

### SUMMARY OF THE INVENTION

Embodiments of the invention facilitate transfer of a vehicle from one dual belt conveyor to another dual belt conveyor, particularly when the wheels of the vehicle are freewheeling such as when the drivetrain is placed in neutral. Transitions between the belts of one conveyor and the belts of another end-to-end oriented conveyor are offset along a direction of travel. The offset transitions result in only one wheel of the vehicle crossing a transition at any one time minimizing resistance acting against the vehicle during the transfer from conveyor to conveyor. Thus, the vehicle is transferred substantially without impedance from one conveyor to another conveyor.

In one broad aspect of the invention, a system for transferring a vehicle along a direction of travel from discharge ends of a first pair of belts to intake ends of a second pair of belts oriented as end-to-end belts, the vehicle having freewheeling wheels, comprises: a pair of passive transitions positioned between the first and second pairs of belts, the transitions being offset along the direction of travel so that only one transitioning, freewheeling wheel is supported on one of the pair of passive transitions at a time and imposes a resistance force at a first resistance threshold thereon; a plurality of cleats spaced along at least one belt of the first pair of belts and; a plurality of cleats spaced along on at least one belt of the second pair of belts, wherein a cleat of the plurality of cleats engages and imposes at least a minimum transitioning force on at least one freewheeling wheel, the at least a minimum transitioning force being greater than the first resistance threshold, for moving each transitioning wheel across the transitions and moving the vehicle between the first and second pairs of belts.

In another broad aspect of the invention, a method for carrying a vehicle, having freewheeling wheels, along a direction of travel from a first dual belt conveyor to a second dual belt conveyor, the vehicle having a first front wheel, a second front wheel, a first rear wheel, and a second rear wheel, comprising: providing a first transition positioned in a gap between a first side belt of the first dual belt conveyor and a first side belt of the second dual belt conveyor, and a second transition positioned in a gap between a second side belt of the first dual belt conveyor and a second side belt of the second dual belt conveyor; offsetting the first transition from the second transition along the direction of travel so that, when one of the first front wheel, second front wheel, first rear wheel or second rear wheel engages either of the first or second transition, all the remaining front and rear wheels are supported on either or both of the first and second dual belt conveyors; moving the first and second side belts of each of the first and second dual belt conveyors in the direction of travel for carrying the vehicle supported thereon; engaging at least one of a front wheel or rear wheel with a pushing cleat of a plurality of spaced cleats on at least one of the first side belt or second side belt of the first dual belt conveyor; pushing the engaged wheel with the pushing cleat until at least one of the front or rear wheels crosses the first or second transition; engaging at least a pulling cleat of a plurality of spaced cleats on at least one of the first side belt or second side belt of the second dual belt conveyor; and pulling at least a last rear wheel of the first or second rear wheel over the remaining second or first transition.

In embodiments of the invention, a first plurality of spaced cleats are formed on the first side belt of the first conveyor and a second plurality of cleats are formed on the second side belt of the second conveyor. Alternatively, either the first and second plurality of cleats are formed on each of the first side belts of the first and second conveyor or on each of the second side belts of the first and second conveyor or are formed on all of the belts of the first and second conveyors. A cleat engaging a wheel on the first conveyor acts to push on the cleat for pushing the vehicle. A cleat engaging a wheel on the second conveyor acts to push on the cleat for pulling the vehicle.

While embodiments of the invention are particularly suitable for transferring a vehicle having freewheeling wheels, the transfer however is also accomplished if at least some of the wheels of the vehicle are in a locked state.

In another broad aspect of the invention, a transition for transferring a freewheeling wheel of a vehicle between end-to-end belts of an endless belt conveyor system and in a direction of travel, comprises: a loop of recirculation rollers adapted to be positioned in a gap between the end-to-end belts, the loop of rollers being passively rotatable in the direction of travel; a fixed intake roller adapted to be supported in a gap between a discharge end of a first belt of the end-to-end belts and the loop of recirculation rollers; and a fixed discharge roller adapted to be supported in a gap between the loop of recirculation rollers and an intake end of a second belt of the end-to-end belts; wherein the fixed intake and discharge rollers are adapted to be spaced sufficiently from the discharge and intake ends of the end-to-end belts to permit unimpeded passage of the end-to-end belts thereby.

### BRIEF DESCRIPTION OF THE DRAWINGS

FIG. 1 is a partial plan view of an embodiment of the invention illustrating a first pair of substantially parallel spaced first and second endless belts forming a first conveyor and a second pair of substantially parallel spaced first and second endless belts forming a second conveyor, the first and second conveyors oriented end to end and having offset transitions positioned between end-to-end first side belts and end-to-end second side belts, portions of a central area between the belts having been removed for clarity;

FIG. 2 is a partial perspective view according to FIG. 1, portions of upper sections of the belts and coverings over a central area between the belts having been removed for clarity;

FIG. 3 is a perspective view of a transition for use between belts of conveyors oriented end-to-end for use in embodiments of the invention;

FIG. 4 is a plan view of the transition according to FIG. 3;

FIG. 5 is a front view of the transition according to FIG. 3;

FIG. 6 is a side view of the transition according to FIG. 3;

FIG. 7 is a side view of the transition according to FIG. 6, a cover removed for viewing fixed and recirculation rollers therein;

FIGS. 8A-8F are a series of schematic side views of the embodiment of FIG. 1 illustrating passage of a cleat formed on an outer surface of one of the belts past a fixed intake roller of the transition of FIG. 3;

FIGS. 9A-9G are a series of schematic side views of first and second side belts of the embodiment of FIG. 1 illustrating passage of first and second side wheels of a vehicle along the belts and over the offset transitions between the end-to-end oriented first and second side belts of the first and second pairs of belts;

FIGS. 10A-10G are perspective views according to FIGS. 9A-9G respectively;

FIGS. 11A1-11D5 are schematic plan views illustrating the effect of engaging different of the wheels with cleats on opposing belts of the first and second pairs of belts;

FIGS. 12A1-12E5 are schematic plan views illustrating the effect of engaging different of the wheels with cleats on same side belts of the first and second pairs of belts;

FIGS. 13 is a side view of a belt of a conveyor, a return portion of the belt being supported by return rollers; and

FIG. 14 is a schematic plan view of a car wash having three dual belt conveyors according to an embodiment of the invention.

### DETAILED DESCRIPTION OF THE PREFERRED EMBODIMENT

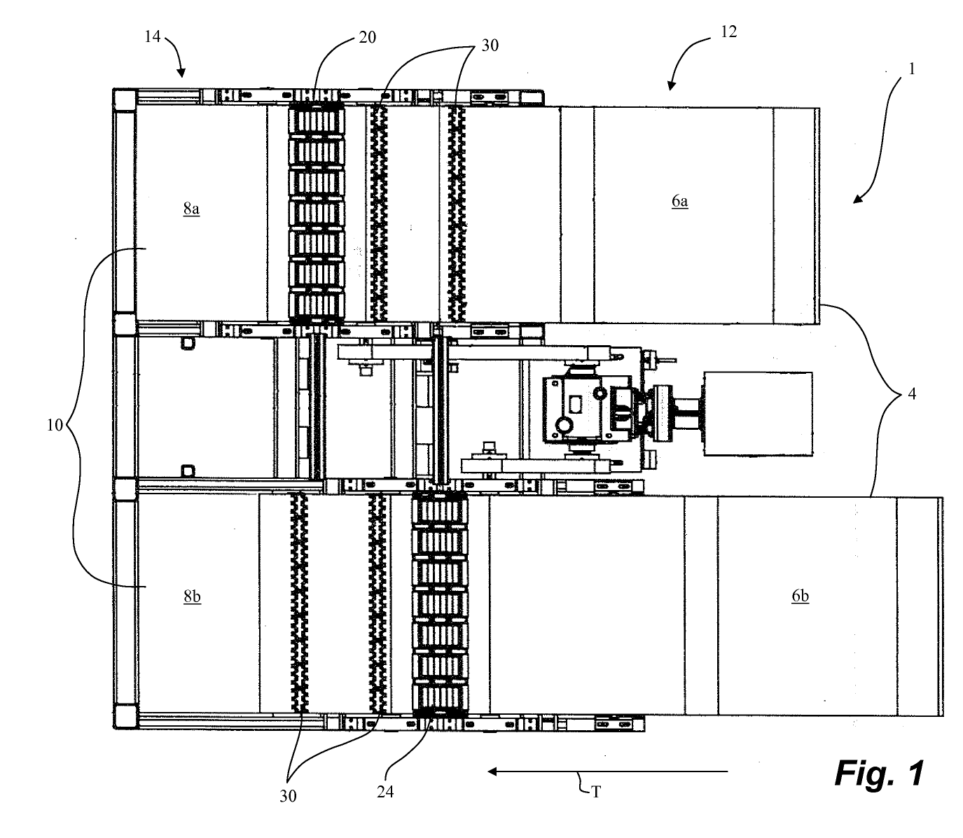

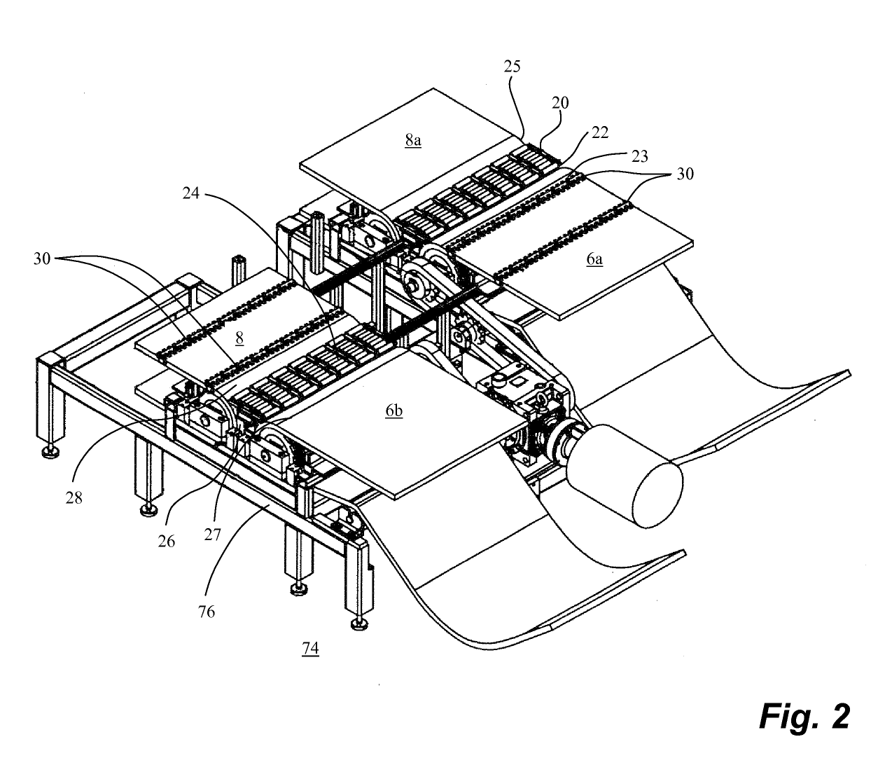

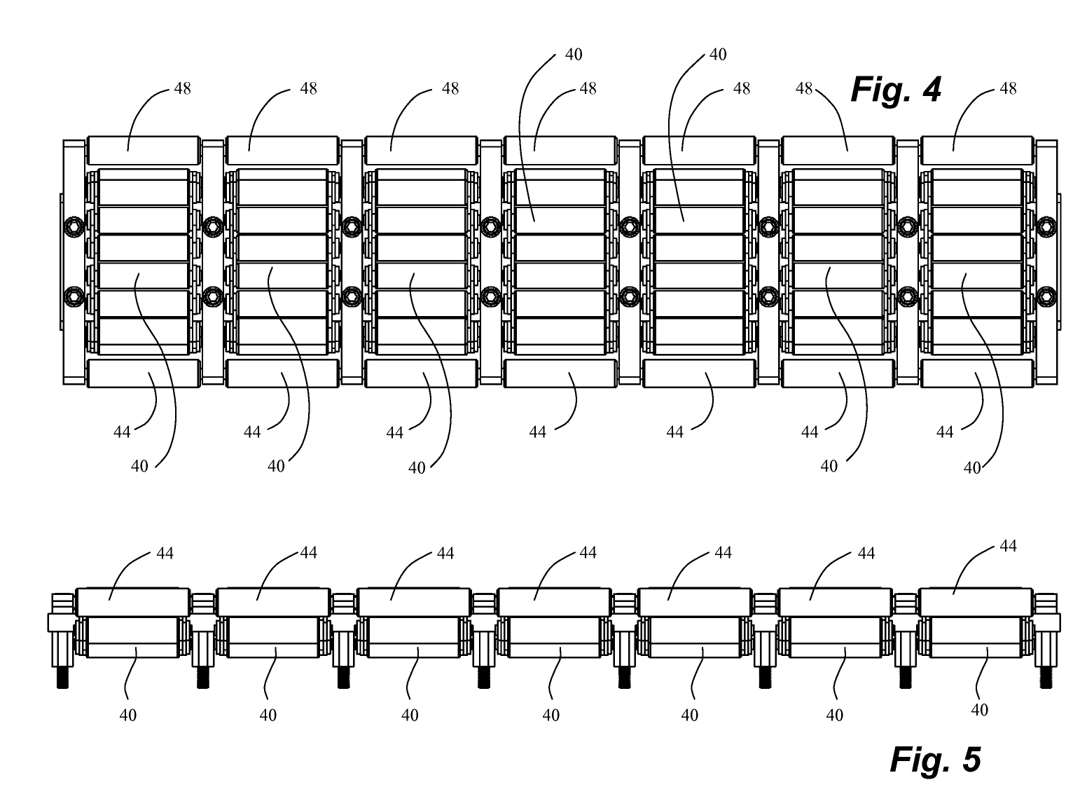

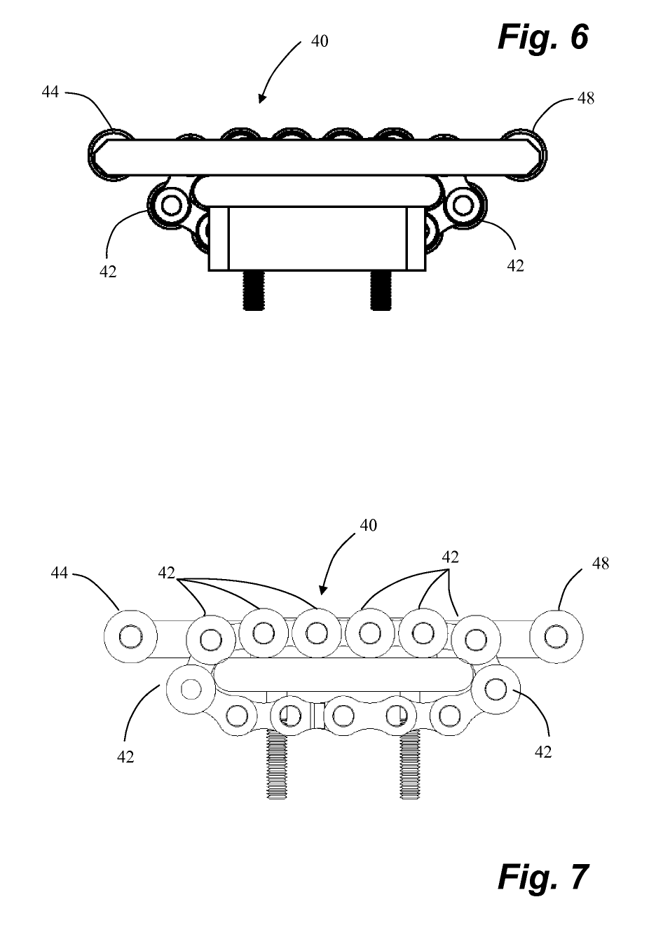

In embodiments of the invention, shown in FIGS. 1-7, a conveyor system 1 carries a vehicle in a direction of travel T. The system 1 is particularly suited for use when a vehicle's wheels 2 are in the rotational or freewheeling state. The system 1 comprises a first pair 4 of substantially parallel first 6a and second 6b spaced apart endless belts and a second pair 10 of substantially parallel spaced apart first 8a and second 8b endless belts. The first pair of belts 4 forms a first dual belt conveyor 12 and the second pair of belts 10 forms a second dual belt conveyor 14. Corresponding of the belts 6a,6b,8a,8b of the first and second dual belt conveyors 12,14 are oriented end-to-end as end-to-end belts.

A first side transition 20 is positioned in a gap 22 between a discharge end 23 of the first side belt 6 a of the first pair of belts 4 and an intake end 25 of the first side belt 8a of the second pair of belts 10. A second side transition 24 is positioned in a gap 26 between the discharge end 27 of the second side belt 8a of the first pair of belts 4 and an intake end 28 of the second side belt 8b of the second pair of belts 10. The transitions 20,24 are passive as the transitions 20,24 do not act to drive the wheels 2 of the vehicle but merely act rollably to support the wheels 2 to transition from conveyor 12 to conveyor 14. Suitable transitions 20,24 could include a roller or rollers.

Cleats 30 are provided to engage the wheels 2 of the vehicle. A plurality of cleats 30 are spaced along at least one belt of the first pair of belts 4 and a plurality of cleats 30 spaced along on at least one belt of the second pair of belts 10. The cleats 30 project from an outer surface 32 of at least one of the first or second side belts 6a, 6b of the first pair of belts 4. The cleats 30 engage at least one wheel 2 of the vehicle to push the wheel 2 of the vehicle. By pushing a wheel 2, a pushing cleat advances the vehicle as the remaining wheels 2 sequentially reach the first or second transition 20, 24. Thus the vehicle is transferred, one wheel 2 at a time over the transitions 20,24 from the first conveyor 12 to the second conveyor 14. As an exception, a last transitioning wheel 2L is pulled over a remaining transition 20,24 by a pulling cleat 30 on the second conveyor 14 pushing on a wheel 2 which has crossed the transitions 20,24. Thus, the action of the cleats 30, pushing on the wheels 2 of the vehicle, causes a push or pull on the vehicle resulting in substantially unimpeded transfer of the wheels 2 across the passive first and second transitions 20, 24 between the conveyors 12, 14.

Further, the first transition 20 is offset relative to the second transition 24 sufficiently such that only one wheel 2 of the vehicle, a transitioning wheel 2t, is crossing either the first or second transition 20, 24 at any one time. The remaining front and rear wheels 2 are supported on either or both of the first and second pairs of belts 4,10 of the first and second conveyors 12, 14. In other words, when any one of the vehicle's wheels 2t is on one of the first or second transition 20,24, there remains three points of contact between the vehicle and the belts 6a,6b,8a,8b of one or both of the conveyors 12, 14. Thus, the only resistance to movement of the vehicle is caused by one wheel 2 at the transitions 20,24.

Gaps 22,26 are found between discharge ends 23,27 and intake ends 25,28 of the belts 6a,6b,8a,8b of the conveyors 12,14. Resistance to movement of the wheels 2 across the transition is at least in part a function of a width of the gap 22,26. At least a portion of the wheel 2 will fall into the gap 22,26 and thereafter must climb out of the gap 22,26 in order to move in the direction of travel T. A wider gap 22,26 will permit a greater portion of the wheel 2 to drop into the gap 22,26 and imposes a higher resistance force against further motion of the wheel 2 in the direction of travel T. A narrower gap 22,26 will engage a lesser portion of the wheel 2 and thus will result in less resistance force against the wheel 2. Additionally, there may be other resistance forces such as a result of the action of the wash brushes against the vehicle creating a cumulative resistance force.

Thus, in embodiments of the invention, the first and second transitions 20,24 are designed to minimize the size of the gap 22,26 while still providing a minimum tolerance for permitting the belts 6a,6b,8a,8b and cleats 30 thereon unimpeded passage by the transitions 20,24. A cleat height is sufficiently high so as to provide at least a minimal cleat or transitioning force to a freewheeling wheel 2 to overcome at least the resistance force when a vehicle encounters a first resistance threshold R1 of one wheel 2 crossing either the first or second transition 20, 24 at any one time.

Having reference again to FIGS. 1-7, and in embodiments of the invention, the transition 20, 24 extends across a length of the gap 22,26 being substantially a width of each of the belts 6a,6b,8a,8b.

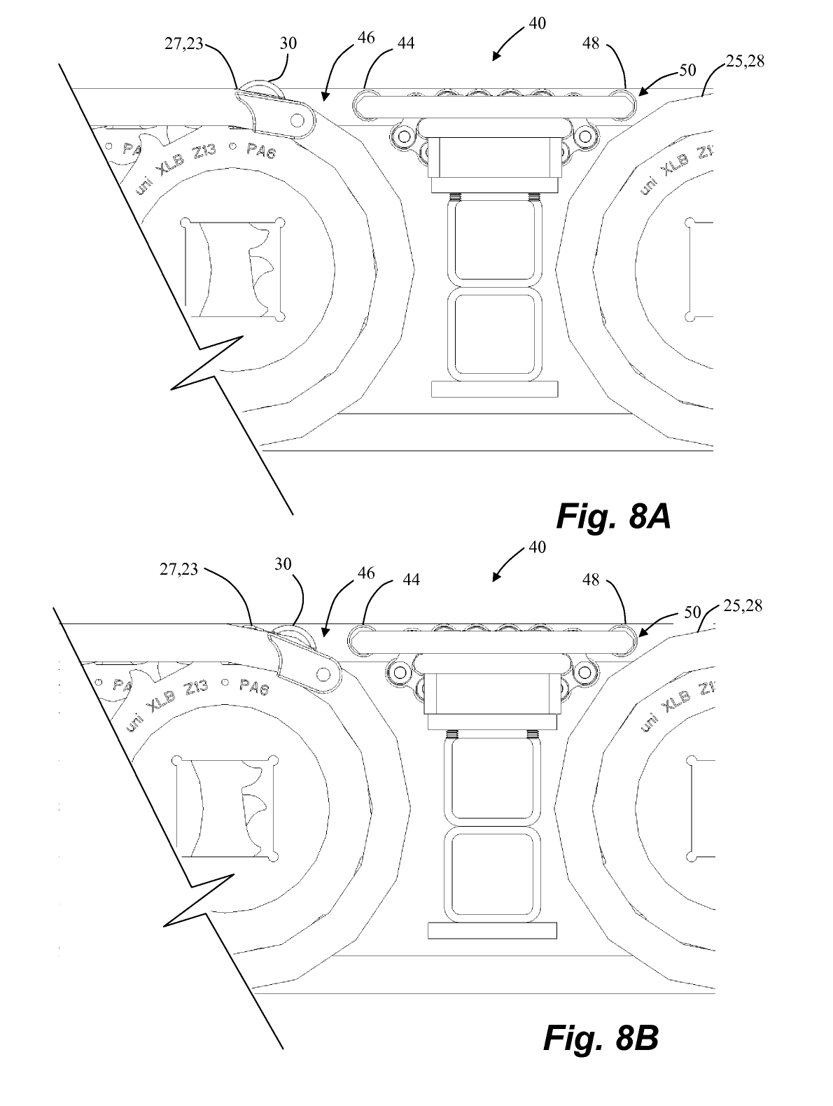

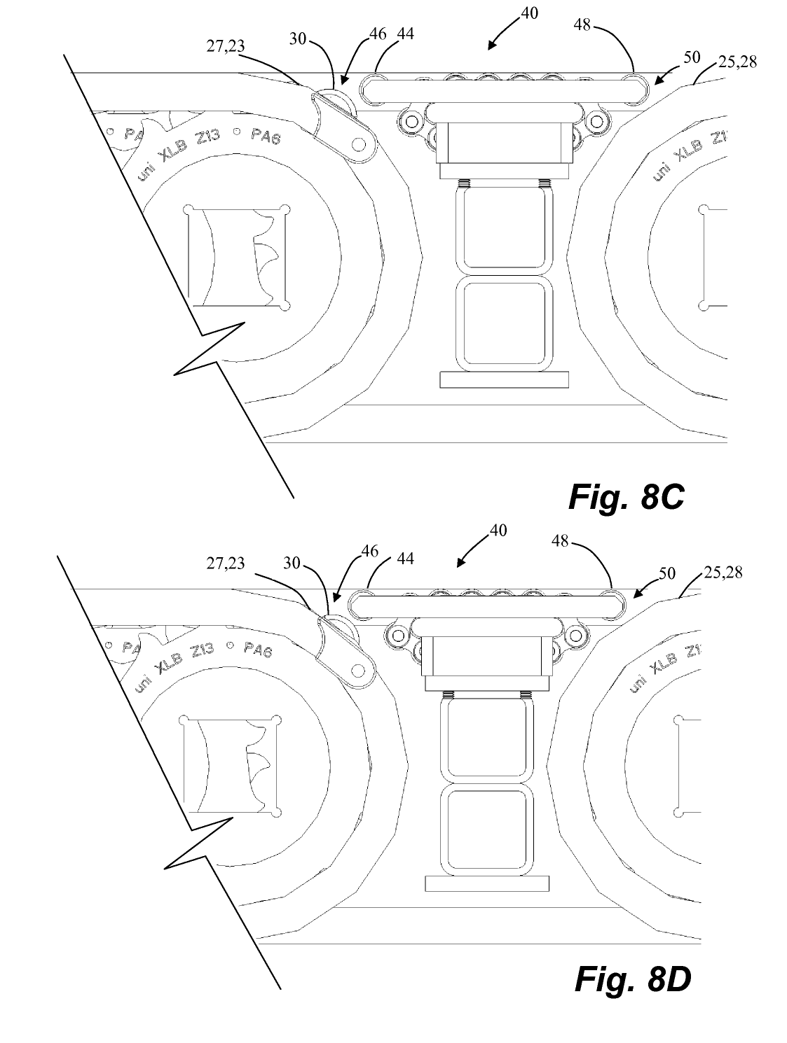

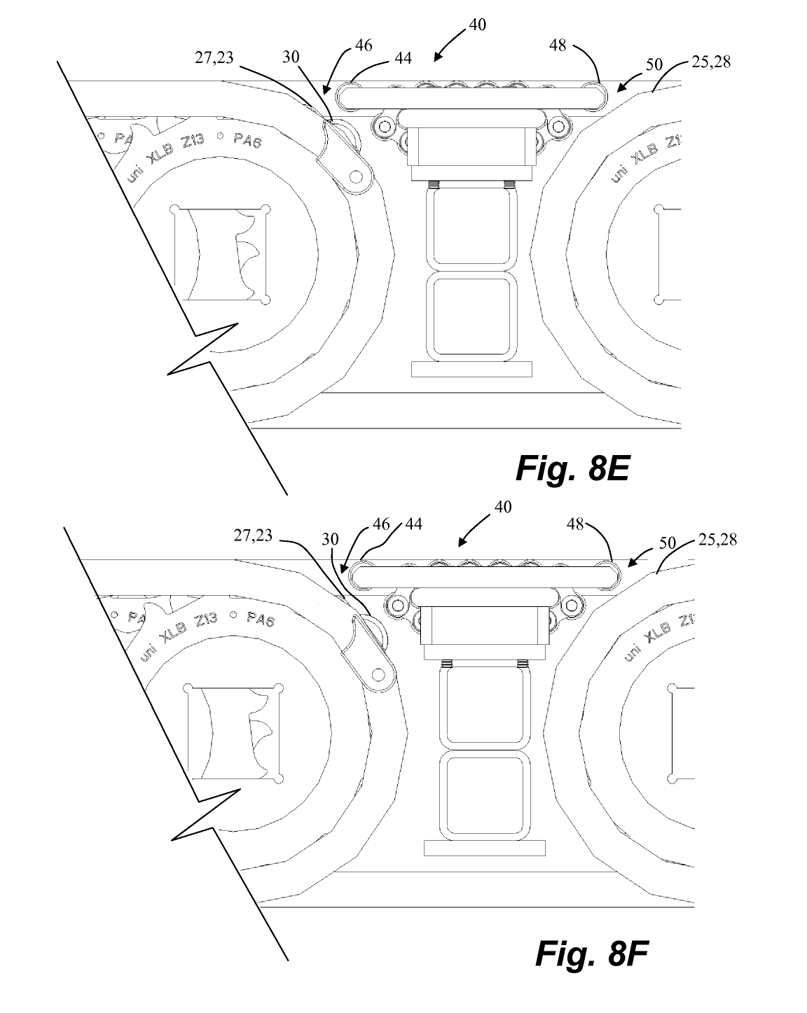

Having reference as well to FIGS. 8A-8F, the offset first and second transitions 20,24 comprise a fixed intake roller 44 adjacent the discharge ends 23,27 of each of the belts 6a,6b of the first conveyor 12 and a fixed discharge roller 48 supported in gap 22,26, adjacent the intake ends 25,28 of each of the belts 8a,8b of the second conveyor 14. The fixed intake roller 44 and the fixed discharge roller 48 are spaced from the discharge ends 23,27 and the intake ends 25,28 of the belts 6a,6b,8a,8b sufficient so as to permit passage of the belts 6a, 6b, 8a, 8b and cleats 30 thereby.

In an embodiment of the invention, the fixed intake and fixed discharge rollers 44,48 are ultra high-molecular weight polyethylene (UHMWPE) rollers so as to be sufficiently strong to support the weight of vehicles thereon and to withstand repeated use. The UHMWPE rollers are mounted on stainless steel shafts, the UHMWPE acting as a bearing on the shafts.

In embodiments of the invention, a plurality of the cleats 30 are spaced along at least one of the first side belts 6a,8a or second side belts 6b,8b of each of the first pair of belts 4 and the second pair of belts 10. The cleats 30 engage and push at least one of the freewheeling wheels 2 of the vehicle for pushing or pulling the vehicle over the first and second transitions 20,24. Where at least one wheel 2 of the vehicle is engaged by a cleat 30 on the first conveyor 12, the vehicle is pushed over the transition 20,24. Where at least a second wheel 2 is engaged by a cleat 30 on the second conveyor 14, the vehicle is pulled over the first and second transitions 20,24.

Each cleat 30, of the plurality of cleats 30, projects upwardly from the belts 6a,6b,8a,8b sufficient to engage and push the wheel 2 with at least minimal cleat or transitioning force required for pushing, pulling, or pushing and pulling the vehicle to overcome at least the first resistance threshold R1 formed when a transitioning wheel 2t engages one of either the first or second transition 20,24.

If the cleat height is too low, the resistance force exceeds the transitioning force and the cleat 30 will pass beneath a freewheeling wheel 2 in lockstep with the wheel 2, lifting the wheel 2 and rotating the wheel 2 backwards causing the vehicle to cease moving forward. In order for this to occur, the resistance force must also be greater than the total of a force vector necessary to lift a normal force of the vehicle supported by the wheel 2. Once lifted, the wheel 2 can then roll backward down a lee side of the cleat 30.

The cleat height is therefore designed to be equal to or greater than the first resistance threshold R1. The minimal cleat or transitioning force is minimally greater than a normal resistance force or first resistance threshold R1 at a transition 20,24 to permit the cleat 30 to typically engage and push a wheel 2 thereover. As a result of using only the minimal transitioning force, the cleat 30 can pass beneath the wheel 2 in the case where there may be a temporary spike in the resistance force, and the wheel 2 can then be engaged by a subsequent spaced cleat 30 for pushing the wheel 2 across the transition 20,24 when the resistance force returns to design levels.

Further, the cleats 30 extend upwardly therefrom sufficiently to permit passage of the cleats 30 beneath at least some of the wheels 2 of the vehicle when remaining of the wheels 2 of the vehicle encounter the first resistance threshold R1. For example the cleats 30 extend upwardly therefrom a sufficient height such that the cleats 30 are safely able to pass under the rear wheels 2R when at least one of the wheels 2 of the vehicle encounters a higher second resistance threshold R2. The higher second resistance threshold R 2 might occur when front wheels 2F, in a locked state, exit the second conveyor 14 onto a fixed surface and freewheeling rear wheels 2R remain on the driven second conveyor 14.

Additionally, the cleats 30 extend upwardly therefrom only a sufficient height such that the cleats 30 are caused to pass under the rear wheels 2R when at least one of the wheels 2 of the vehicle encounters a even higher third resistance threshold R3. The even higher third resistance threshold R3 might occur when front wheels 2F, in a locked state, exit the second conveyor 14 onto a fixed surface and locked rear wheels 2R remain on the moving, second conveyor 14.

In the case of a vehicle where the wheels 2 are in a locked state, the resistance force must exceed the total of the force vector and a frictional resistance force to drag the cleat 30 across the locked wheel's surface.

The second and third resistance thresholds R2, R3 are established so that damage to the vehicle is avoided.

While the description provided thus far has been restricted to the discussion of first and second pairs of belts 4,10 forming the first and second dual belt conveyors 12,14, one of skill in the art would appreciate that embodiments of the invention are not limited to only two conveyors. It is within the scope of the invention to provide an infinite number of conveyors oriented end-to-end and having transitions supported therebetween.

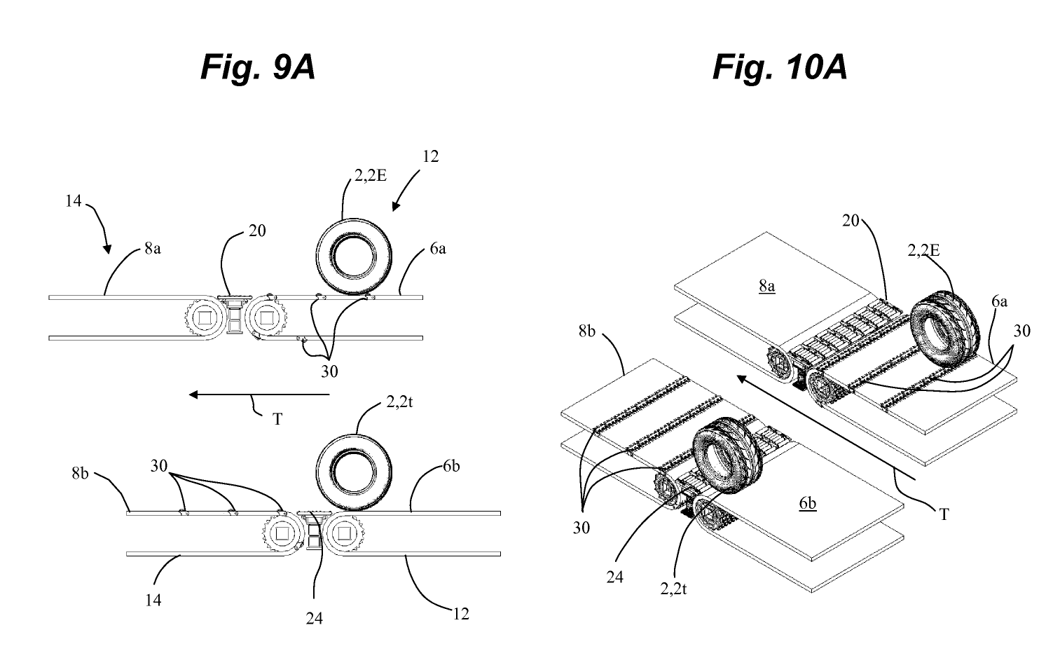

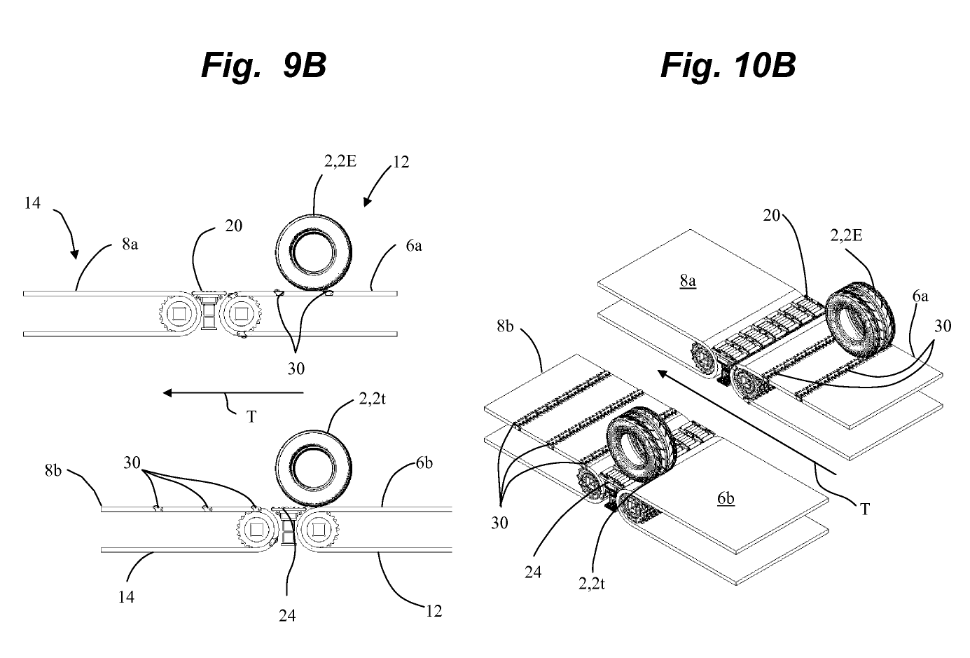

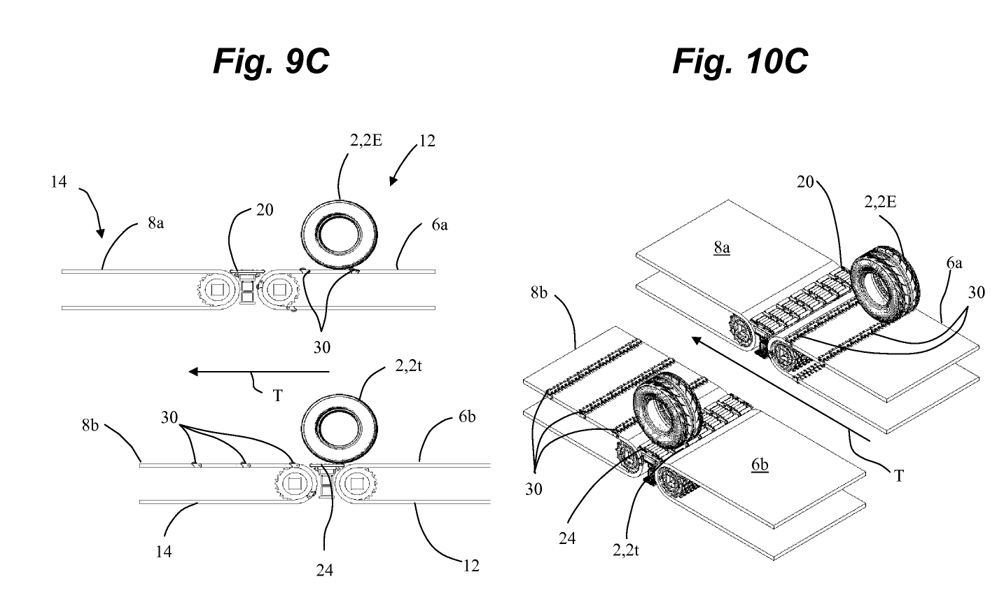

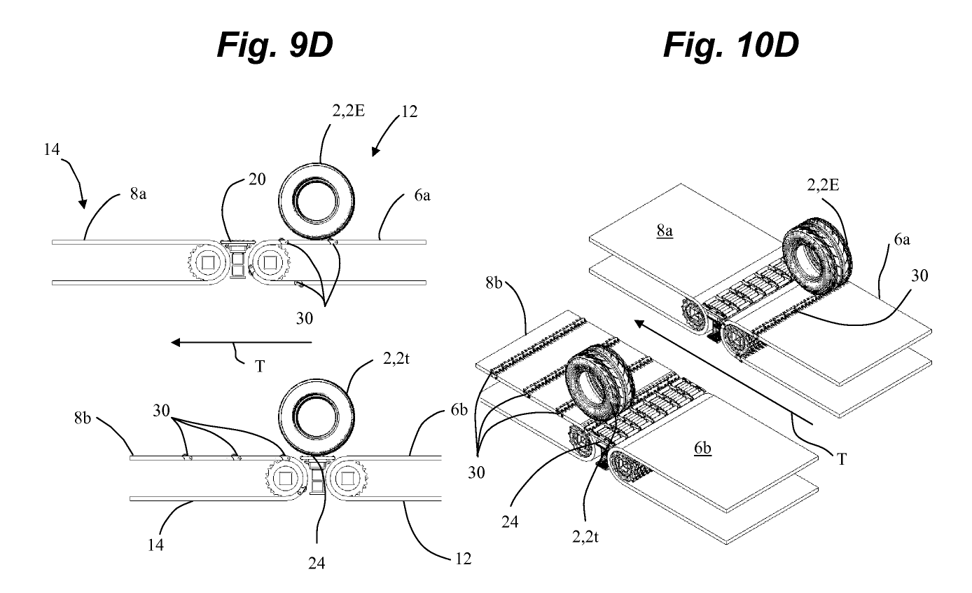

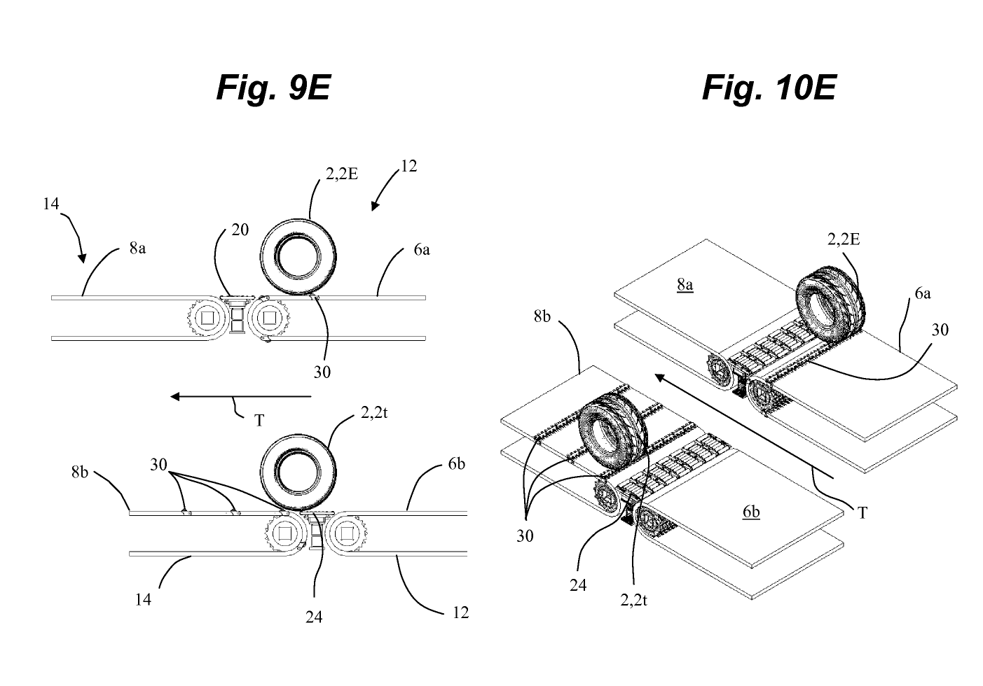

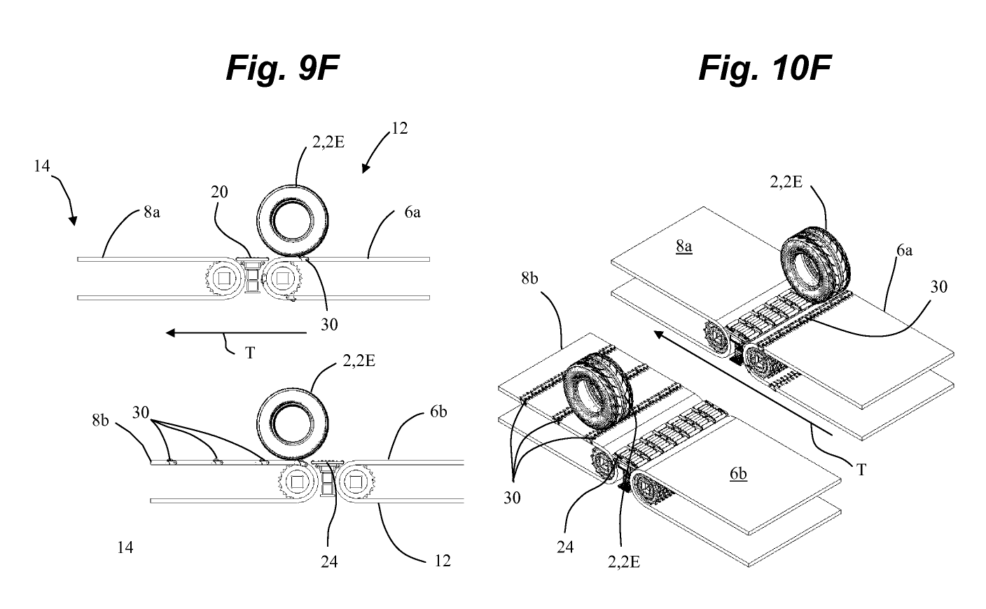

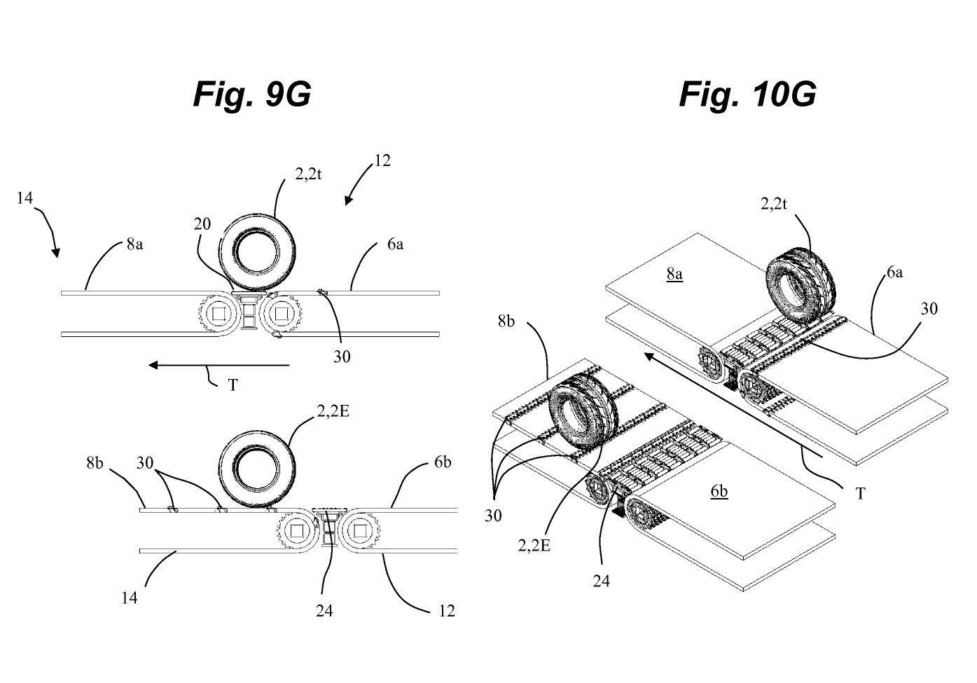

In operation, as shown in FIGS. 9A-9G, 10A-10G, 11A1-11D5 and 12A1-12E5, an operator drives a vehicle onto the first dual belt conveyor 12. The state of the vehicle can be non-rotational or locked, including placing the drivetrain in Park or engaging the foot brake or emergency brake or can be rotational or freewheeling, such as placing the drivetrain in Neutral.

In an embodiment of the invention, a first plurality of spaced cleats 30 are formed on the first side belt 6a of the first dual belt conveyor 12 and a second plurality of spaced cleats 30 are formed on the second side belt 8b of the second dual belt conveyor 14.

In this embodiment, the first and second conveyors 12,14 are driven for carrying the vehicle in the direction of travel T. A cleat 30 on the first side belt 6a is caused to engage at least one of a first front wheel 2F1 or a first rear wheel 2R1 on a first side of the vehicle. The cleat 30, having a design height as previously described, acts to push the engaged first front or first rear wheel 2E as remaining wheels 2 sequentially encounter resistance force at the transitions 20,24 and acts with at least the minimal transition force to overcome the resistance force so as to move the transitioning wheel 2t of the vehicle over the transitions 20,24.

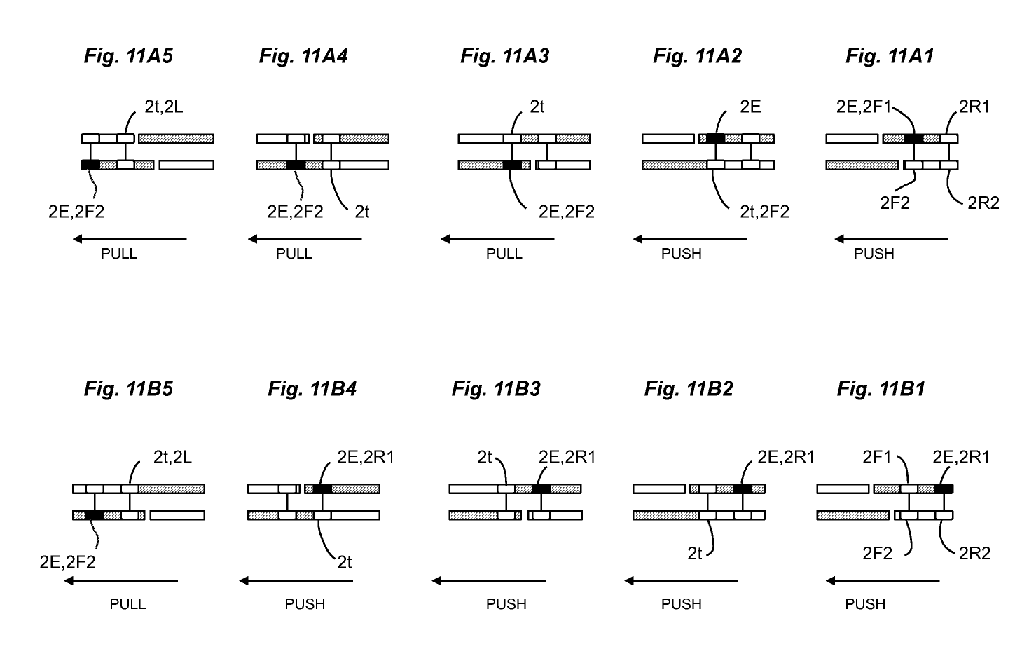

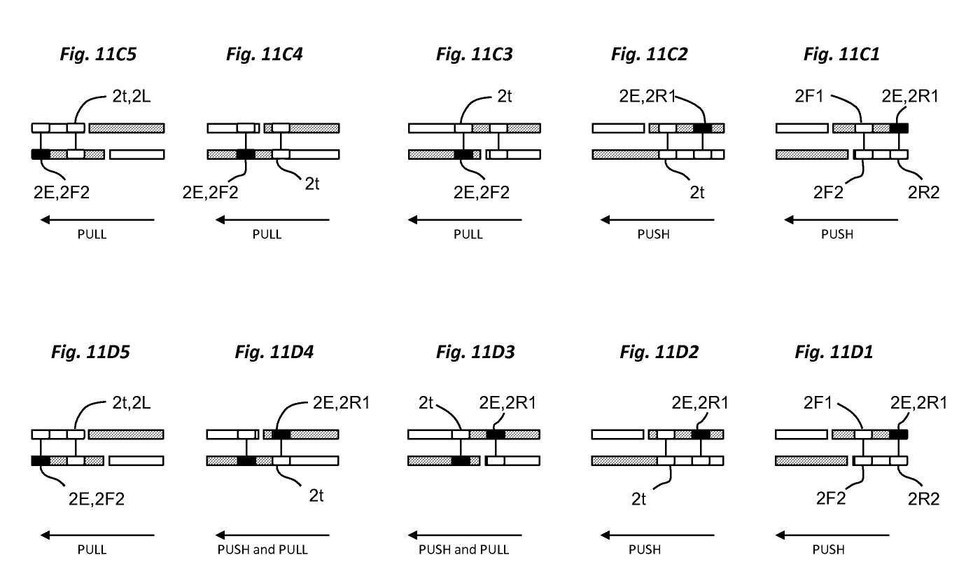

If the cleat 30 on the first side belt 6a of the first conveyor 12 engages the first front wheel 2F1 (FIG. 11A1), the cleat 30 pushes a second front wheel 2F2 on the second side belt 6b, now the transitioning wheel 2t, over the second transition 24 (FIG. 11A2), after which the second front wheel 2F2 is engaged by a cleat 30 on the second side belt 8b (FIG. 11A3) for sequentially pulling the remaining wheels 2, being the first front wheel 2F1 (FIG. 11A3) and both of a second rear wheel 2R2 and a first rear wheel 2R1, being the last wheel 2L (FIGS. 11A4 and 11A5), over the first and second transitions 20,24.

As shown in FIGS. 11B1-11B5, if the cleat 30 on the first side belt 6a of the first conveyor 12 engages the first rear wheel 2R1 on the first side of the vehicle (FIG. 11B1), the cleat 30 acts to sequentially push the second front wheel 2F2 (FIG. 11B2), the first front wheel 2F1 (FIG. 11B3) and the first rear wheel 2R1 (FIG. 11B4) over the second and first transitions 20,24, respectively. Either the second front wheel 2F2 (FIG. 11B5) or possibly the second rear wheel (not shown) thereafter engages a cleat 30 on the second side, cleated belt 8b of the second conveyor 14 for pulling the first rear wheel 2R1, over the first transition 20.

Alternatively, as shown in FIGS. 11C1-11C5, if the cleat 30 on the first side belt 6a of the first conveyor 12 engages the first rear wheel 2R1 on the first side of the vehicle (FIG. 11C1), the cleat 30 acts to push the second front wheel 2F2 (FIG. 11C2) over the second transition 24. The second front wheel 2F2 (FIG. 11B5) may thereafter engage a cleat 30 on the second side cleated belt 8b of the second conveyor 14 for sequentially pulling the first front wheel 2F1 over the first transition 20, the second rear wheel 2R2 over the second transition 24 and the first rear wheel 2R1 over the first transition 20.

Alternatively as shown in FIGS. 11D1-11D5, if the cleat 30 on the first side belt 6a of the first conveyor 12 engages the first rear wheel 2R1 (FIG. 11D1) for pushing the second front wheel 2F2 over the second transition 24 (FIG. 11D2) as previously described, the first rear wheel 2R1 may remain engaged with the cleat 30 on the first side belt 6a when the second front wheel 2F2 engages a cleat 30 on the second side belt 8b of the second conveyor 14 (FIG. 11D3), the two engaged wheels 2R1,2F2 thereafter act together to push and pull the first front wheel 2F1 (FIG. 11D3) and the second rear wheel 2R2 (FIG. 11D4) over the first and second transitions 20,24, respectively, Once the first rear wheel 2R1 reaches the first transition 20, only the second front wheel 2F2 remains engaged with the cleat 30 on the second side belt 8b of the second conveyor 14 and it acts to pull the remaining first rear wheel 2R1 over the first transition 20 (FIG. 11D5).

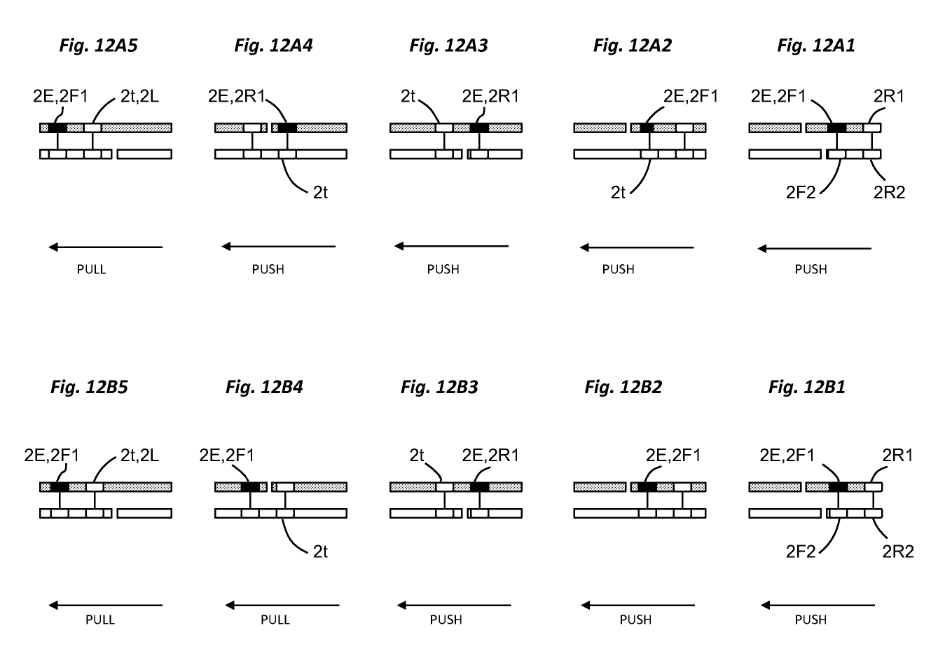

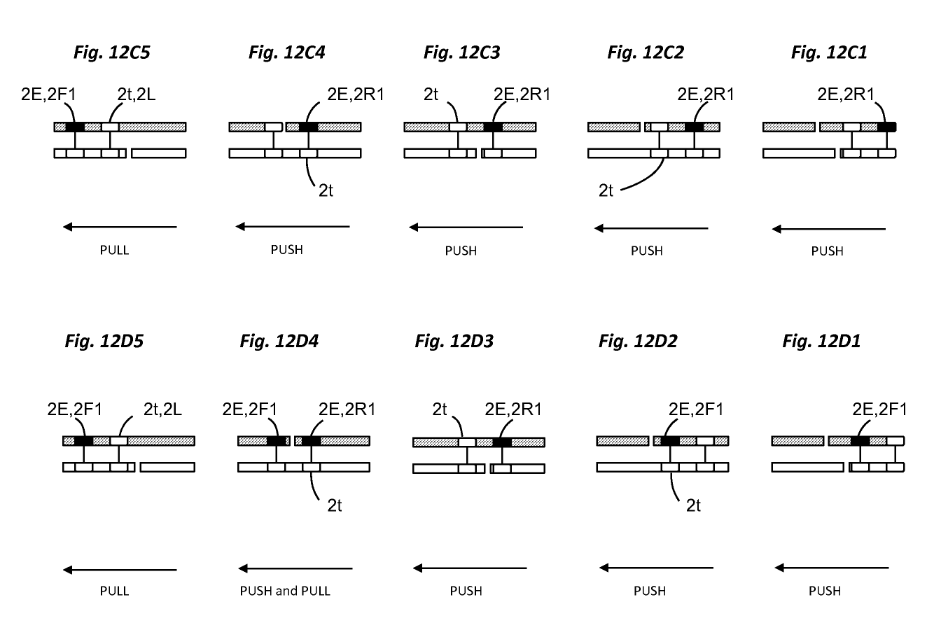

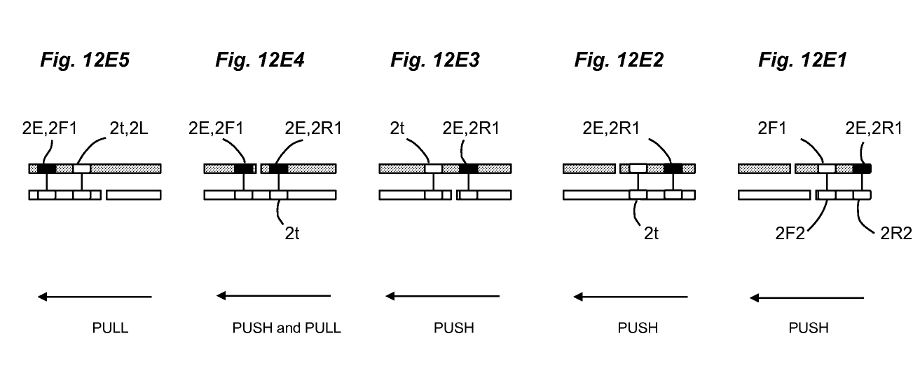

In an embodiment of the invention shown in FIGS. 12A1-12E5, a plurality of spaced cleats 30 are formed on either of the first or second side belt 6a,6b of the first conveyor 12 and on the same side, being the first or second side belt 8a,8b on the second conveyor 14. Thus only wheels 2 on one side of the vehicle are engaged by the cleats 30 for pushing and pulling the vehicle over the transitions 20,24.

If the cleat 30 on the first side belt 6a of the first conveyor 12 engages the first front wheel 2F1 (FIG. 12A1), the cleat 30 pushes the second front wheel 2F2 on the second side belt 6b over the second transition 24 (FIG. 12A2). When the first front wheel 2F1 engages the first transition 20 (FIG. 12A3), the first rear wheel 2R1 is engaged by a cleat 30 on the first side belt 6a for pushing the first front wheel 2F1 over the first transition 20. The first rear wheel 2R1 remains engaged with the cleat 30 for pushing the second rear wheel 2R2 over the second transition 24 (FIG. 12A4) after which the first front wheel 2F1 engages a cleat 30 on the first side belt 8a of the second conveyor 14 (FIG. 12A5) for pulling the first rear wheel 2R1, being the last wheel 2L (FIGS. 11A4 and 11A5), over the first transition 20.

Alternatively, as shown in FIGS. 12B1-12B5, if the cleat 30 on the first side belt 6a of the first conveyor 12 engages the first front wheel 2F1 (FIG. 12B1), the cleat 30 pushes the second front wheel 2F2 on the second side belt 6b over the second transition 24 (FIG. 12B2). When the first front wheel 2F1 engages the first transition 20 (FIG. 12B3), the first rear wheel 2R1 is engaged by a cleat 30 on the first side belt 6a for pushing the first front wheel 2F1 over the first transition 20. The front wheel 2F1 thereafter engages with the cleat 30 on the first side belt 8a of the second conveyor 14 for pulling the second rear wheel 2R2 (FIG. 12B4) over the second transition 24 and the first rear wheel 2R1, being the last wheel 2L (FIG. 12B5), over the first transition 20.

As shown in FIGS. 12C1-12C5, if the cleat 30 on the first side belt 6a of the first conveyor 12 engages the first rear wheel 2R1 on the first side of the vehicle (FIG. 12C1), the cleat 30 acts to sequentially push the second front wheel 2F2 (FIG. 12C2), the first front wheel 2F1 (FIG. 12C3) and the first rear wheel 2R1 (FIG. 12C4) over the second and first transitions 20,24, respectively. Thereafter, the first front wheel 2F1 (FIG. 11B5) engages a cleat 30 on the first side belt 8a of the second conveyor 14 for pulling the first rear wheel 2R1, over the first transition 20.

Alternatively, as shown in FIGS. 12D1-12D5, if the cleat 30 on the first side belt 6a of the first conveyor 12 engages the first front wheel 2F1 on the first side of the vehicle (FIG. 12D1), the cleat 30 acts to push the second front wheel 2F2 (FIG. 12D2) over the second transition 24. When the first rear wheel 2R1 engages the first transition 20, the first rear wheel 2R1 engages a cleat 30 on the first side belt 6a of the first conveyor for pushing the first front wheel 2F1 over the first transition 20. Thereafter, the first front wheel 2F1 may engage a cleat on the first side belt 8a of the second conveyor 14, the first rear wheel 2R1 remaining engaged with a cleat 30 and thus the second rear wheel 2R2 is both pushed and pulled over the second transition 24. As soon as the first rear wheel 2R1 reaches the first transition, it releases the cleat 30 and the first rear wheel 2R1 is pulled over the first transition 20.

Alternatively, as shown in FIGS. 12E1-12E5, if the cleat 30 on the first side belt 6a of the first conveyor 12 engages the first rear wheel 2R1 (FIG. 12E1) for pushing the second front wheel 2F2 over the second transition 24 (FIG. 12E2) and the first front wheel 2F1 over the first transition 20 (FIG. 12E3), as previously described, the first rear wheel 2R1 may remain engaged with the cleat 30 on the first side belt 6 a when the first front wheel 2F1 engages a cleat 30 on the first side belt 8a of the second conveyor 14 (FIG. 12E4). The two engaged wheels 2R1,2F1 thereafter act together to push and pull the second rear wheel 2R2 (FIG. 112E4) over the first and second transitions 20,24, respectively, Once the first rear wheel 2R1 reaches the first transition 20 (FIG. 12E5), only the first front wheel 2F1 remains engaged with the cleat 30 on the first side belt 8a of the second conveyor 14 and it acts to pull the remaining first rear wheel 2R1 over the first transition 20 (FIG. 12E5).

In the case where the plurality of spaced cleats 30 are formed on all of the belts 6a,6b,8a,8b, the spacing of the cleats 30 between the first side belt 6a,8a and the second side belt 6b,8b of the first and the second conveyors 12,14 are preferably synchronized. Any number or all of the wheels 2 of the vehicle may be engaged by a cleat 30 on any of the cleated belts 6a,6b,8a,8b for pushing the wheels 2. Depending upon which of the wheels are engaged and with which cleats 30, the wheels 2 of the vehicle are pushed and pulled over the transitions 20, 24, the last transitioning wheel 2L being pulled over the second transition 24.

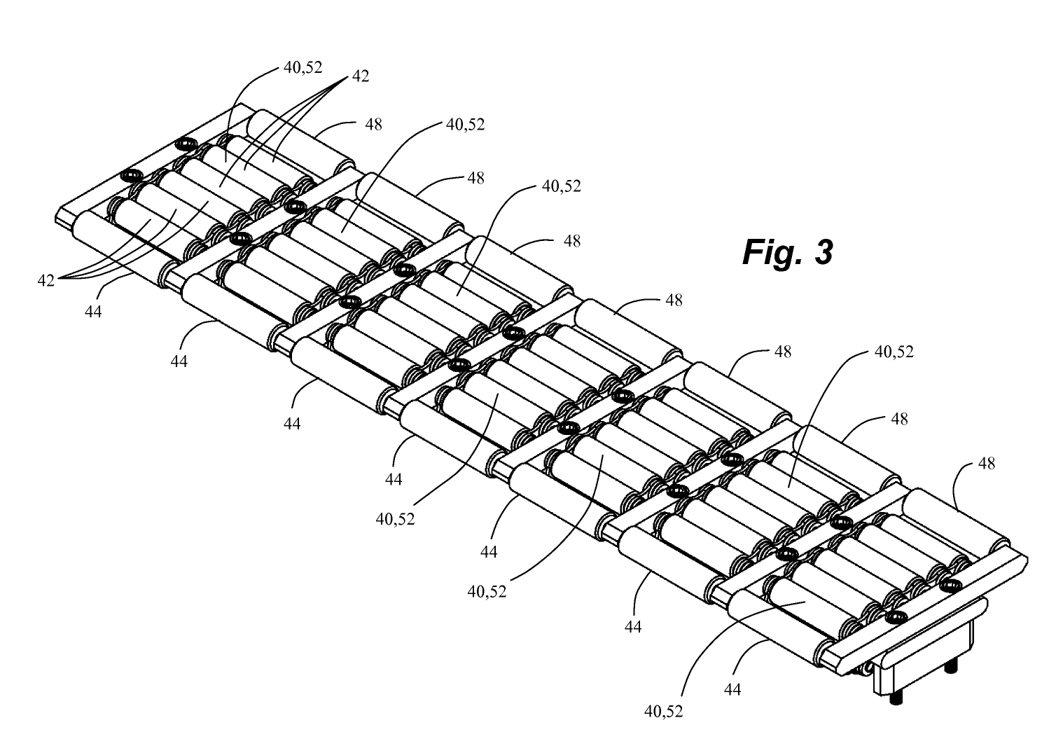

In embodiments of the invention particularly suited for cold climates, best seen in FIGS. 3-7 and 8A-8F, each of the first and second transitions 20,24 further comprises a loop 40 of recirculation rollers 42 positioned in the gap 22,26 between the first conveyor 12 and the second conveyor 14 and extending across a width of the transition 20, 24. The loop 40 is positioned between the fixed intake roller 44 and the fixed discharge roller. The loop 40 is oriented so that the loop 40 is passively rotatable in the direction of travel T, each of the rollers 42 therein also being rotatable so as to break up any ice which tends to form thereon.

In embodiments of the invention the rollers 42 are made of stainless steel, such as recirculation rollers 42 available from Hillman Rollers, Marlboro, N.J., 07746, USA.

The fixed intake roller 44 forms a discharge gap 46 between the discharge ends 23,27 of each of the first and second side belts 6a, 6b of the first dual belt conveyor 12 and the loop 40 of recirculation rollers 42 of the first and second transitions 20, 24, respectively. The fixed discharge roller 48 forms an intake gap 50 between the loop 40 of recirculation rollers 42 of the first and second transitions 20, 24 and the intake ends 25,28 of each of the first and second side belts 8a, 8b of the second dual belt conveyor 14. The fixed intake and fixed discharge rollers 44,48 are sized so as to substantially fill the discharge gap 49 and the intake gap 50 while leaving sufficient space therein to permit unimpeded passage of the endless belts 6a,6b,8a,8b and the cleats 30 thereby.

In an embodiment of the invention, the fixed intake roller 44, the loop 40 of recirculation rollers 42 and the discharge roller 48 form a set of transition rollers 52 having a limited length dictated by the load the set of transition rollers 52 can support. A plurality of sets of transition rollers 52 are positioned substantially parallel and side-by-side across the length of the gap 22,26 for forming the transition 20,24 to extend across a width of each belt. A width of each of the plurality of recirculation rollers 42 and the plurality of fixed intake and fixed discharge rollers 44,48 is selected such that each wheel 2 on the vehicle contacts at least a portion of each of two recirculation rollers 42,42, two fixed intake rollers 44,44 and two fixed discharge rollers 48,48 as the wheel 2 crosses the transition 20,24, regardless the positioning of the wheel 2 across the length of the transition 20,24.

### EXAMPLE A

In one example, as shown in FIGS. 1-7, embodiments of the invention are used in a car wash to move a vehicle into and through a wash tunnel 70. The first pair 4 of substantially parallel endless first 6a and second 6b side belts form an entrance conveyor 12 which extends from external the wash tunnel 70 and into an entrance 72 of the wash tunnel 70 and onto which the operator drives the vehicle.

Once inside the entrance 72 of the wash tunnel 70, a second pair 10 of substantially parallel endless first 8a and second 8b side belts forms a wash conveyor 14 which is oriented end-to-end with the entrance conveyor 12. First and second transitions 20,24 according to an embodiment of the invention are supported between the first side belt 6a of the entrance conveyor 12 and the first side belt 8a of the wash conveyor 14 and the second side belt 6b of the entrance conveyor 12 and the second side belt 8b of the wash conveyor 14. The vehicle is transferred from the entrance conveyor 12, over the transitions 20,24 and onto the wash conveyor 14, by the motion of the conveyors 12,14 in the direction of travel T and by the action of the cleats 30 to provide at least a minimal transitioning force to overcome at least a resistance force encountered as each of the wheels 2 of the vehicle sequentially reach and engage the first and second transitions 20,24.

The vehicle can be placed in neutral (freewheeling state) or in park or the foot brakes or emergency brake can be applied (locked state) without affecting the operation of the carwash's conveyors 12,14 to move the vehicle through the car wash.

The height to which the cleats 30 project upwardly from the belts 6a,6b,8a,8b of the conveyors 12,14 is finely balanced to provide the at least the minimal transitioning force to overcome the resistance force while minimizing the 49,50 required between the transitions' fixed intake rollers 44 and fixed discharge rollers 48 and the cleats 30 for permitting passage of the cleats 30 and belts 6a,6b,8a,8b thereby. If the cleat 30 does not extend high enough, the resistance force may permit the wheel 2 to roll backward over the cleat 30 as the wheel 2 engages the transition as previously described. If however, the cleat is higher to increase the transitioning force, causing the gaps 49,50 to be much larger, the resistance force may become too great and the transition force of the higher cleat is insufficient to overcome the greater resistance force as previously discussed.

Should there be additional, instantaneous resistance at the moment a wheel 2 reaches a transition 20,24, the engaged cleat 30E may not be able to provide sufficient transition force to overcome the instantaneous resistance force. The cleat would therefore be unable to push the wheel 2 onto and over the transition 20,24. In this case, the engaged cleat 30E may be caused to slip under the wheel 2. The wheel 2 is then engaged up by a following cleat 30 which, provided the resistance force has returned to a design magnitude, will cause the wheel 2 to be moved onto and over the transition 20,24.

The transition force caused by the cleats 30 pushing on a wheel 2 acts as either a vehicle pushing force or a vehicle pulling force depending upon which of the cleats 30 on which of the belts 6a,6b,8a,8b engages at least one wheel 2 of the vehicle.

The first and second side belts 6a,6b,8a,8b of the entrance and wash conveyors 12,14, referred to as “the belts” for the purposes of the following discussion, are supported above a floor 74 of the car wash tunnel by a support frame system 76 such as is understood by one of skill in the art. Each of the belts 6a,6b,8a,8b is about 896 mm (about 35 inches) in width. The belts 6a,6b,8a,8b of each of the entrance and wash conveyors 12,14 are spaced about 710 mm (about 28 inches) apart. Thus, each conveyor 12,14 is capable of supporting thereon a wide range of vehicles having from a minimum to a maximum known wheel base. Further, if the driver does not center the vehicle on the belt 6a,6b,8a,8b, regardless how far to one edge or the other of the belts 6a,6b,8a,8b the vehicle is positioned, the wheels 2 will be engaged by both of the belts 6a,6b,8a,8b regardless a width of the vehicle from wheel 2F1,2R1 to wheel 2F2, 2R2.

The first and second transitions 20,24 are offset from each other along the direction of travel by about 520 mm (about 20 inches) such that, even when a vehicle has a short wheel base, only one wheel 2 of the vehicle will engage and cross one transition 20,24 at any one time. The remaining wheels 2 provide at least three points of contact between the vehicle and the belts 6a,6b,8a,8b for maintaining vehicle positioning on the belts 6a,6b,8a,8b and reduce the resistance force encountered by the vehicle at the transitions 20,24.

Particularly advantageous in a car wash embodiment, the action of the recirculation rollers 42 acts to break up and prevent ice build up at the transitions 20,24 when used in climates which are susceptible to freezing temperatures.

In an embodiment of the invention, the support frame system 76 is positioned within a trench in the wash tunnel 70. A plurality of cleats 30 are spaced about 320 mm (about 13 inches)±63.5 mm (2.5 inches) apart along a length of the first side belt 6a of the first conveyor 12 and the opposing second side belt 8b of the second conveyor 14. The cleats 30 in cross-section are arcuate in profile to assist the cleat to pass under the wheels 2 of the vehicle should it be necessary to do so. The cleats 30 project upwardly about 12.5 mm (about 0.49 inch) to engage the wheels 2 of the vehicle and prevent the vehicle when placed in neutral, from rolling backward on the entrance conveyor 12, particularly when the entrance conveyor 12 is put into motion. Further, the cleats 30 extend transversely across substantially an entirety of the width of the belt 6a,6b,8a,8b.

In one embodiment of the invention, the cleats 30 and at least portions of the belts 6a,6b,8a,8b may be perforated to permit drainage of wash fluids therethrough. The endless belts 6a,6b,8a,8b are modular plastic belts formed using a plurality of interconnected links upon which the cleats 30 are formed or otherwise attached thereto.

The entrance and wash conveyors 12,14 are generally sloped about 12 mm (0.49 inches) to about 19 mm (0.75 inches) over the length of the entrance and wash conveyors, being about 25 m (82 feet), to encourage drainage and aid in ensuring forward momentum of the vehicle.

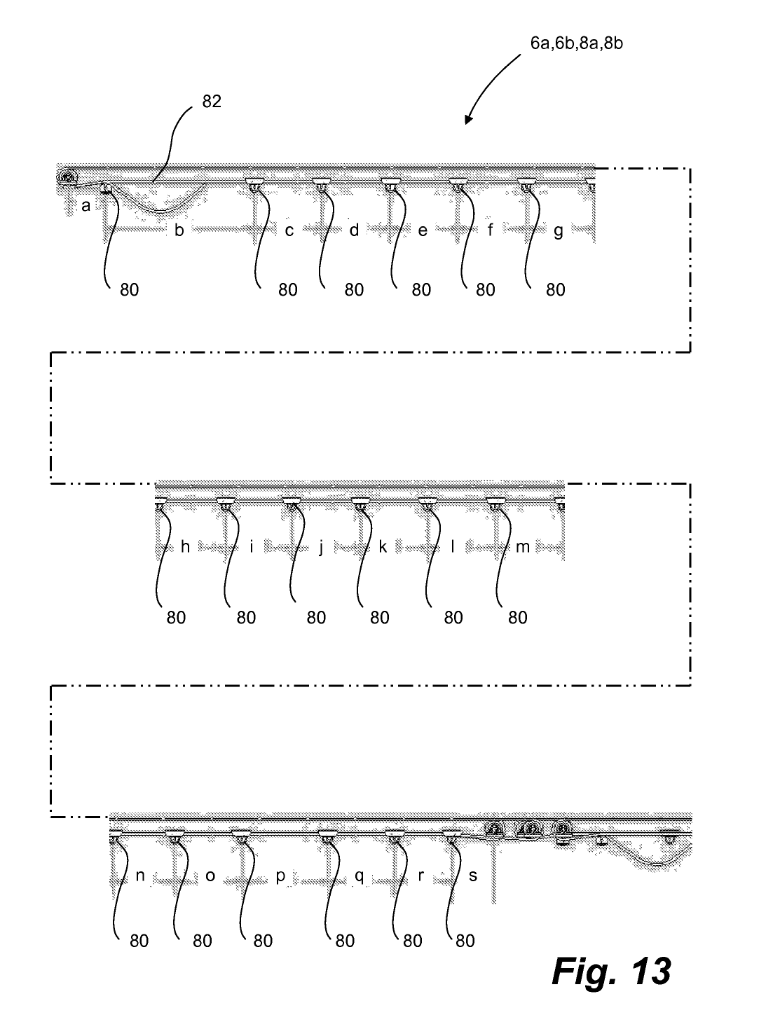

Having reference to FIG. 13, a plurality of return rollers 80 extend transversely beneath a lower, return portion 82 of each of the endless belts 6a,6b,8a,8b for supporting the return portion 82 thereon. The plurality of return rollers 80 are variably spaced along a length of each of the belts 6a,6b,8a,8b so as to minimize harmonics which can occur such as when the plurality of return rollers 80 are spaced evenly therealong. Typically, there is a certain amount of slack tolerated in the return portion of the belts 6a,6b,8a,8b as a result of belt elasticity, expansion and contraction, resulting from changes in temperature, wear conditions and the like. The variably spaced return rollers 80 support the return portion 82 of the belts 6a,6b,8a,8b thereon so as to minimize the harmonic effects in the return portion 82 between the plurality of variably spaced return rollers 80 for maximizing smooth operation of the belts 6a,6b,8a,8b.

In the embodiment of the invention shown in FIG. 13, the plurality of return rollers 80 are variably spaced along the length of the belt's return portion 82 as shown in Table A.

TABLE A

| Return portion belt | Spacing between return | Spacing between return |
|---|---|---|
| segment | rollers (inches) | rollers (m) |
| a | 43.6 | 1.107 |
| b | 78.5 | 1.994 |
| c | 35.5 | 0.902 |
| d | 36.5 | 0.927 |
| e | 35.5 | 0.902 |
| f | 36.2 | 0.919 |
| g | 36.0 | 0.914 |
| h | 36.0 | 0.914 |
| i | 35.5 | 0.902 |
| j | 36.5 | 0.927 |
| k | 35.5 | 0.902 |
| l | 36.5 | 0.927 |
| m | 36.0 | 0.914 |
| n | 32.5 | 0.826 |
| o | 35.0 | 0.889 |
| p | 45.0 | 1.143 |
| q | 35.0 | 0.889 |
| r | 30.0 | 0.762 |
| s | 22.2 | 0.564 |

Further, a diameter of the return rollers 80 is larger than conventionally used so as to permit the cleats 30 on the outer surface 32 of the belts 6a,6b,8a,8b to climb the return rollers 80 with minimal impedance of the motion of the belts 6a,6b,8a,8b thereover.

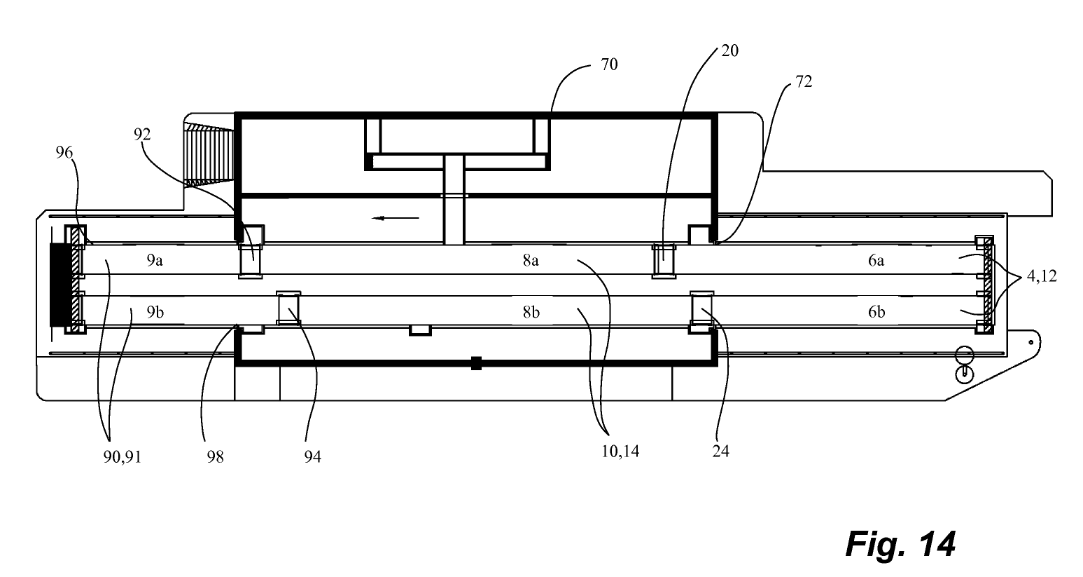

In an embodiment of the invention shown in FIG. 14, it is contemplated to use three dual belt conveyors, such as the entrance conveyor 12, the wash conveyor 14 and a discharge conveyor 90. The discharge conveyor 90 is a dual belt conveyor comprising a third pair 91 of first side and second side belts 9a,9b oriented end-to-end to the first and second side belts 8a,8b of the wash conveyor 14. A third transition 92 and a fourth transition 94 are positioned between the first side belt 8a of the wash conveyor 12 and the first side belt 9a of the discharge conveyor 90 and the second side belt 8b of the wash conveyor 12 and the second side belt 9b of the discharge conveyor 90, respectively. A discharge end 96 of the discharge conveyor 90 causes the vehicle to be discharged onto a fixed surface located outside an exit 98 of the wash tunnel 70.

### EXAMPLE B

Design of an optimum cleat height, as previously described, finely balances the height of the cleat so as to provide at least a minimum transitioning force to push against a wheel of the vehicle to overcome at least a first minimum resistance threshold acting against another wheel of the vehicle at either of the first or second transition.

A worst case scenario for design of the cleat height is a vehicle having small wheels, where more of the wheel is engaged by the gaps and therefore the resistance is greater to the forward movement of the wheel over the transitions.

In one embodiment of the invention, an optimum cleat height was determined for a 1989 Pontiac Firefly having a tire size of 33 cm (13 inches).

As Table B illustrates, increasing the cleat height to attempt to achieve a greater pushing or transitioning force requires an increase in the discharge and intake gaps so as to permit the higher cleat to pass thereby. The increase in the gap size required to accommodate the higher cleat results in an increased resistance force acting against the wheels of the vehicle.

TABLE B

| | | | Resistance | Transitioning |
|---|---|---|---|---|
| Cleat Height | Gap mm | | Force | Force |
| mm | *Roller/Cleat | *Roller/Belt | lbs | lbs |
| 0 | 3.5 | 3.5 | 15-20 | 0 |
| 2.5 | 3.5 | 6 | 15-20 | 5 |
| 5 | 3.5 | 8.5 | 15-20 | 10 |
| 7.5 | 3.5 | 11 | 20-25 | 15 |
| 10 | 3.5 | 13.5 | 25-30 | 25 |
| 12.5 | 3.5 | 16 | 30-40 | 40 |
| 15 | 3.5 | 18.5 | 40-60 | 55 |
| 17.5 | 3.5 | 21 | 60-90 | 75 |

*“Roller” refers to the fixed intake or discharge rollers

As one of skill would appreciate, an optimum height of 12.5 mm is minimally sufficient to overcome the resistance force during normal operations. Cleat heights of less than 12.5 mm do not provide sufficient transitioning force to overcome the resistance force. Increasing the cleat height above 12.5 mm results in a transitioning force which may be insufficient over the complete range of the resistance force and therefore is unreliable to transition a wheel of the vehicle during operation.

The embodiments of the invention in which an exclusive property or privilege is claimed are defined as follows:

1. A system for transferring a vehicle along a direction of travel from discharge ends of a first pair of belts to intake ends of a second pair of belts oriented as end-to-end belts, the vehicle having freewheeling wheels, the system comprising:
a pair of passive transitions positioned between the first and second pairs of belts, the transitions being offset along the direction of travel so that only one transitioning, freewheeling wheel is supported on one of the pair of passive transitions at a time and imposes a resistance force at a first resistance threshold thereon;
a plurality of cleats spaced along at least one belt of the first pair of belts and;
a plurality of cleats spaced along on at least one belt of the second pair of belts,
wherein a cleat of the plurality of cleats engages and imposes at least a minimum transitioning force on at least one freewheeling wheel, the at least a minimum transitioning force being greater than the first resistance threshold, for moving each transitioning wheel across the transitions and moving the vehicle between the first and second pairs of belts.

2. The system of claim 1 wherein:
each of the first pair of belts and second pair of belts comprises:
a first side belt; and
a second side belt; and
the pair of passive transitions comprises:
a first transition positioned between a discharge end of the first side belt of the first pair of belts and an intake end of the first side belt of the second pair of belts; and
a second transition positioned between a discharge end of the second side belt of the first pair of belts and an intake end of the second side belt of the second pair of belts.

3. The system of claim 1 wherein the minimum transitioning force on the vehicle is a pushing force or a pulling force.

4. The system of claim 1 wherein each cleat, of the plurality of cleats on the first and second pairs of belts, projects upwardly therefrom sufficiently to engage the wheels for providing the minimum transitioning force to overcome at least the first resistance threshold at the each of the pair of passive transitions.

5. The system of claim 2 wherein each cleat of the plurality of cleats, on the first and second pairs of belts, projects upwardly therefrom sufficiently to permit passage of the plurality of cleats beneath at least some of the freewheeling wheels of the vehicle when remaining of the wheels of the vehicle encounter a second resistance threshold being higher than the first resistance threshold.

6. The system of claim 5 wherein each cleat of the plurality of cleats project upwardly on the first and second pairs of belts sufficiently to permit passage of the plurality of cleats beneath at least some of the wheels of the vehicle which are locked when remaining of the wheels of the vehicle encounter a third resistance threshold being higher than the second resistance threshold.

7. The system of claim 1 wherein a cross-section of each cleat of the plurality of cleats is arcuate in profile.

8. The system of claim 2 wherein each cleat of the plurality of cleats on the first and second pairs of belts extends transversely across substantially an entirety of a width of the first or second side belts of the first and second pairs of belts.

9. The system of claim 2 further comprising:
a plurality of spaced cleats on one of the first or second side belts of the first pair of belts and an opposing second or first side belt of the second pair of belts.

10. The system of claim 2 further comprising:
a plurality of spaced cleats on each of the first side belt and the second side belt of each of the first and second pairs of belts.

11. The system of claim 2 further comprising:
a plurality of spaced cleats on the each of the first side belts of each of the first and second pairs of belts or on each of the second side belts of each of the first and second pairs of belts.

12. The system of claim 2 further comprising:
a third pair of first and second side belts oriented end-to-end to the second pair of first and second side belts, at least one of the first or second side belts of the third pair of belts having a plurality of spaced cleats extending upwardly from an outer surface therefrom on at least an opposing of the second and first side belts of the second pair of belts;
a third transition positioned between a discharge end of a first side belt of the second pair of belts and an intake end a first side belt of the third pair of belts; and
a fourth transition positioned between a discharge end of a second side belt of the second pair of belts and an intake end of a second side belt of the third pair of belts;
wherein the third transition is sufficiently offset from the fourth transition such that when one wheel of the vehicle engages one of the third or fourth transitions, remaining wheels of the vehicle engage either or both of the second and third pairs of belts.

13. The system of claim 2 wherein each of the first and the second transitions comprise:
a loop of recirculation rollers positioned between the discharge ends and the intake ends, the loop of rollers being passively rotatable in the direction of travel;
a fixed intake roller supported in an intake gap between the discharge ends and the loop of recirculation rollers; and
a fixed discharge roller supported in a discharge gap between the loop of recirculation rollers and the intake ends;
wherein the fixed intake and discharge rollers are spaced sufficiently from the discharge ends and intake ends to permit unimpeded passage thereby of the end-to-end belts and the plurality of cleats thereon.

14. The system of claim 12 wherein each of the third transition and the fourth transition comprise:
a loop of recirculation rollers positioned between the discharge ends and the intake ends, the loop of rollers being passively rotatable in the direction of travel;
a fixed intake roller supported in an intake gap between the discharge ends and the loop of recirculation rollers; and
a fixed discharge roller supported in a discharge gap between the loop of recirculation rollers and the intake ends;
wherein the fixed intake and discharge rollers are spaced sufficiently from the discharge ends and intake ends to permit unimpeded passage thereby of the end-to-end belts and the plurality of cleats thereon.

15. The system of claim 2 wherein
the first pair of belts form an entrance conveyor of a car wash; and
the second pair of belts form a wash conveyor of the car wash.

16. The system of claim 12 wherein the third pair of belts forms a discharge conveyor in a car wash.

17. The system of claim 14 wherein at least a portion of the first and second pairs of belts and plurality of cleats formed thereon are perforated to permit drainage of fluids therethrough.

18. The system of claim 15 wherein at least a portion of the third pair of belts and plurality of cleats formed thereon are perforated to permit drainage of fluids therethrough.

19. The system of claim 1 wherein the first pair of belts and the second pair of belts are formed of interconnected links.

20. The system of claim 19 further comprising:
a plurality of variably spaced return rollers positioned beneath a return portion of each of the first pair of belts and the second pair of belts so as to minimize harmonics therein.

21. A method for carrying a vehicle, having freewheeling wheels, along a direction of travel from a first dual belt conveyor to a second dual belt conveyor, the vehicle having a first front wheel, a second front wheel, a first rear wheel, and a second rear wheel, comprising:
providing a first transition positioned in a gap between a first side belt of the first dual belt conveyor and a first side belt of the second dual belt conveyor, and a second transition positioned in a gap between a second side belt of the first dual belt conveyor and a second side belt of the second dual belt conveyor;
offsetting the first transition from the second transition along the direction of travel so that, when one of the first front wheel, second front wheel, first rear wheel or second rear wheel engages either of the first or second transition, all the remaining front and rear wheels are supported on either or both of the first and second dual belt conveyors;
moving the first and second side belts of each of the first and second dual belt conveyors in the direction of travel for carrying the vehicle supported thereon;
engaging at least one of a front wheel or rear wheel with a pushing cleat of a plurality of spaced cleats on at least one of the first side belt or second side belt of the first dual belt conveyor;
pushing the engaged wheel with the pushing cleat until at least one of the front or rear wheels crosses the first or second transition;
engaging at least a pulling cleat of a plurality of spaced cleats on at least one of the first side belt or second side belt of the second dual belt conveyor; and
pulling at least a last rear wheel of the first or second rear wheel over the remaining second or first transition.

22. The method of claim 21 further comprising:
forming a first plurality of cleats on the first side belt of the first dual belt conveyor; and
forming a second plurality of cleats on the second side belt of the second dual belt conveyor.

23. The method of claim 21 further comprising:
forming a first plurality of cleats on the first side belt of the first dual belt conveyor; and
forming a second plurality of cleats on the first side belt of the second dual belt conveyor.

24. The method of claim 21 wherein the plurality of cleats are formed on the first side belt of the first dual belt conveyor and the second side belt of the second dual belt conveyor, further comprising:
engaging the first rear wheel with a pushing cleat on the first side belt of the first dual belt conveyor;
pushing the engaged first rear wheel with the pushing cleat until the second front wheel crosses the second transition;
engaging the second front wheel with a pulling cleat on the second side belt of the second dual belt conveyor; and
pulling the first and second rear wheels over the first and second transitions.

25. The method of claim 21 wherein the plurality of cleats are formed on the first side belt of the first dual belt conveyor and the second side belt of the second dual belt conveyor, further comprising:
engaging the first rear wheel with a pushing cleat on the first side belt of the first dual belt conveyor;
pushing the engaged first rear wheel with the pushing cleat until the first and second front wheels cross the first and second transitions and the second rear wheel crosses the second transition;
engaging the second front wheel with a pulling cleat on the second side belt of the second dual belt conveyor; and
pulling the first rear wheel over the first transition.

26. The method of claim 21 wherein the plurality of cleats are formed in the first side belt of the first dual belt conveyor and the second side belt of the second dual belt conveyor, further comprising:
engaging the first rear wheel with a pushing cleat on the first side belt of the first dual belt conveyor;
pushing the engaged first rear wheel with the pushing cleat until the second front wheel is over the second transition;
engaging the second front wheel with a pulling cleat on the second side belt of the second dual belt conveyor;
pushing the engaged first rear wheel and pulling the engaged second front wheel for pushing and pulling the second rear wheel over the second transition; and
pulling the engaged second front wheel for pulling the first rear wheel over the first transition.

27. The method of claim 21 wherein the plurality of cleats are formed on the first side belt of the first dual belt conveyor and the second side belt of the second dual belt conveyor, further comprising:
engaging a first front wheel with a pushing cleat on the first side belt of the first dual belt conveyor;
pushing the engaged first front wheel with the pushing cleat until the second front wheel is over the second transition;
engaging a pulling cleat on the second side belt of the second dual belt conveyor; and
pulling the first front wheel over the first transition and the first and second rear wheels over the first and second transitions.

28. A transition for transferring a freewheeling wheel of a vehicle between end-to-end belts of an endless belt conveyor system and in a direction of travel, the transition comprising:
a loop of recirculation rollers adapted to be positioned in a gap between the end-to-end belts, the loop of rollers being passively rotatable in the direction of travel;
a fixed intake roller adapted to be supported in a gap between a discharge end of a first belt of the end-to-end belts and the loop of recirculation rollers; and
a fixed discharge roller adapted to be supported in a gap between the loop of recirculation rollers and an intake end of a second belt of the end-to-end belts;
wherein the fixed intake and discharge rollers are adapted to be spaced sufficiently from the discharge and intake ends of the end-to-end belts to permit unimpeded passage of the end-to-end belts thereby.

29. The transition of claim 28 wherein the loop of recirculation rollers, the fixed intake roller and the fixed discharge roller, form a set of transition rollers, the transition further comprising:
a plurality of sets of transition rollers positioned side-by-side and substantially parallel and extending transversely across a length of the gap between the end-to-end belts for forming the transition.

30. The transition of claim 28 wherein the recirculation rollers are stainless steel rollers.

31. The transition of claim 28 wherein the fixed intake rollers and the fixed discharge rollers are ultra high-molecular weight polyethylene rollers.

32. The transition of claim 31 wherein the ultra high-molecular weight polyethylene rollers are mounted on stainless steel shafts, the ultra high-molecular weight polyethylene acting as a bearing thereon.

33. The transition of claim 28 wherein the fixed intake rollers and the fixed discharge rollers are adapted to be spaced sufficiently from the discharge and intake ends of the end-to-end belts to permit unimpeded passage thereby of the end-to-end belts and a plurality of cleats thereon.
